(19) United States
(12) Patent Application Publication
(10) Pub. No.: US 2019/0281656 A1
(43) Pub. Date: Sep. 12, 2019

(54) INFORMATION INDICATION METHOD, INFORMATION RECEIVING METHOD, AND APPARATUS

(71) Applicant: Huawei Technologies Co., Ltd., Shenzhen (CN)

(72) Inventors: Weimin WU, Wuhan (CN); Xingyu WEN, Wuhan (CN); Jian YU, Shenzhen (CN)

(21) Appl. No.: 16/425,385

(22) Filed: May 29, 2019

Related U.S. Application Data
(63) Continuation of application No. PCT/CN2017/113350, filed on Nov. 28, 2017.

(30) Foreign Application Priority Data
Nov. 29, 2016 (CN) 201611072323.7

(51) Int. Cl. H04W 80/02; H04W 72/04; H04L 5/00; H04L 1/16; H04L 1/00; H04J 13/00

(52) U.S. Cl. CPC H04W 80/02; H04W 72/0446; H04L 5/0055; H04J 13/0022; H04L 1/0004; H04J 13/0062; H04J 13/0048; H04L 1/1614

(57) ABSTRACT

The disclosure relates to an information indication method, an information receiving method, and an apparatus. The information indication method includes: sending, by an access point, a data frame to at least one station, where the data frame is a non-aggregated frame or an aggregated frame obtained by aggregating N MAC frames, N is a positive integer greater than 1 and is less than or equal to M, and M is a maximum allowable quantity of aggregated MAC frames; sending, by the access point, trigger information to the at least one station, where the trigger information is used to instruct the at least one station to reply with an acknowledgement frame on a shared resource unit; and receiving, by the access point, the acknowledgement frame fed back by the at least one station on the shared resource unit.

### CROSS-REFERENCE TO RELATED APPLICATIONS

This application is a continuation of International Application No. PCT/CN2017/113350, filed on Nov. 28, 2017, which claims priority to Chinese Patent Application No. 201611072323.7, filed on Nov. 29, 2016. The disclosures of the aforementioned applications are hereby incorporated by reference in their entireties.

### TECHNICAL FIELD

The present invention relates to the field of communications technologies, and in particular, to an information indication method, an information receiving method, and an apparatus.

### BACKGROUND

For Wi-Fi standards, especially for a high-rate application scenario, a supported rate can exceed 1 Gbps. However, a device such as a sensor or a meter reading device does not have a high rate requirement, and a required rate is usually dozens of Kbps. In addition, for this type of service, a data amount is not very huge either, and some data on the meter reading device is usually uploaded. Usually, one data packet includes only dozens of bytes. Such a station (station, STA) that does not have not a high rate requirement or a very huge data amount is referred to as an Internet of Things (Internet of Things, IoT) STA.

FIG. 1 is a schematic diagram of a scenario in which an access point (access point, AP) interacts with a plurality of STAs. In an interaction process, Wi-Fi uses a wireless air interface to transmit data, and as a result, the data is often not successfully received by a recipient due to interference and a poor channel environment. To determine whether the recipient correctly receives the data, an acknowledgement mechanism is introduced and is usually implemented by using acknowledgement information. The acknowledgement information may include an acknowledgement (acknowledgement, ACK) frame and a block acknowledgement (block ack, BA) frame, and may further include a multi-TID BA frame and an M-BA frame, where TID is a traffic identifier (traffic identifier, TID).

In the Wi-Fi 802.11ac standard, a downlink multi-user multiple-input multiple-output (downlink multiple-user multiple-input multiple-output, DL MU-MIMO) mechanism is introduced, so that an AP can simultaneously perform transmission with a plurality of STAs by using different spatial streams. In addition, in the 802.11ax standard, an uplink (uplink, UL) MU-MIMO transmission mechanism, and uplink and downlink orthogonal frequency division multiple access (orthogonal frequency division multiple access, OFDMA) transmission are also introduced. In the 802.11ax standard, two different physical layer packet formats are introduced to respectively perform downlink and uplink multi-user transmission.

Based on a single-user format, a multi-user format (multiple-user format, MU format) cites simultaneous transmission of a plurality of users. As specified in an existing protocol version, the multi-user format is a dedicated format used when an AP performs downlink transmission with a plurality of STAs. A format used during uplink multi-user transmission in which a plurality of STAs simultaneously perform transmission with an AP is referred to as a trigger based uplink format (trigger based uplink format). FIG. 2 shows a structure of a packet in a multi-user format. First, a legacy preamble is included. The legacy preamble includes a legacy short training field (legacy short training field, L-STF), a legacy long training field (legacy long training field, L-LTF), and a legacy signal field (legacy signal field, L-SIG), to ensure backward compatibility, so that a STA can understand the legacy preamble. In addition, a repeated legacy signal field (repeated L-SIG) is further included, and is used to perform automatic detection and enhance robustness of the L-SIG by using a repetition feature. A high efficient signal field A (high efficient signal field A, HE-SIG-A) is used to carry signaling information such as a basic service set color (basic service set color, BSS Color), a spatial multiplexing parameter, and transmit opportunity duration (transmit opportunity duration, TXOP Duration). A high efficient signal field B (high efficient signal field B, HE-SIG-B) is mainly used to carry resource scheduling information of a plurality of STAs in a BSS. A high efficient short training field (high efficient short training field, HE-STF) and a high efficient long training field (high efficient long training field, HE-LTF) are subsequently included, and are respectively used to perform automatic gain control (automatic gain control, AGC) and channel measurement of multiple input multiple output (multiple input multiple output, MIMO). The HE-LTF field may include a plurality of HE-LTF symbols used to perform channel measurement on a plurality of space-time streams. A last part is a data (data) part that is used to carry a media access control (media access control, MAC) frame.

In the trigger based uplink format (trigger based uplink format), uplink transmission performed by a plurality of users needs to be synchronized, and the plurality of users need to know in advance respective location and physical layer parameters used during transmission. Therefore, an AP first needs to send a trigger frame (trigger frame, TF) to STAs. After receiving the trigger frame, the plurality of STAs simultaneously perform uplink multi-user transmission based on resource scheduling information in the trigger frame. Therefore, the uplink multi-user transmission format is referred to as the trigger based uplink format, and FIG. 3 shows a structure of a packet in the trigger based uplink format. Different from the multi-user format, the trigger based uplink format no longer has an HE-SIG-B. Because the AP notifies a STA of a parameter including resource scheduling information, the STA does not need to notify the AP of the parameter during uplink transmission.

Therefore, the trigger based uplink format allows an AP to trigger a plurality of STAs to simultaneously perform uplink transmission. In addition, the AP may not specify a STA to perform uplink transmission, but uses an OFDMA random contention mode to enable a STA that successfully obtains a channel through contention, to perform uplink transmission. Based on the trigger based uplink format, a STA not only can obtain a transmit opportunity through independent channel contention, but also can obtain an uplink transmit opportunity through random contention.

Generally, a manner in which OFDMA ACK/BA is used to respond to downlink multi-user transmission is used. FIG. 4 is a schematic diagram of an acknowledgement process of downlink multi-user transmission. The schematic diagram includes a multi-user acknowledgement mechanism including six STAs. During uplink multi-user transmission, a scheduling parameter of uplink transmission needs to be indicated by using trigger information in a trigger frame. Therefore, when sending downlink data, an AP needs to send trigger information of an acknowledgement frame. The trigger information may be carried by using a MAC frame header in a data frame or carried by using a unicast trigger frame aggregated with a data frame. For the acknowledgement process of downlink multi-user transmission, data of an IoT STA usually includes only dozens of bytes. In this case, 14 bytes are required even if a relatively short ACK frame is used, causing relatively large overheads. If a BA frame is used for feedback, overheads become larger and even exceed a length of the data itself.

For an acknowledgement process of uplink multi-user transmission, as shown in FIG. 5a, an AP first needs to send a trigger frame to a plurality of STAs, then the plurality of STAs simultaneously perform uplink multi-user transmission, and finally the AP sends an acknowledgement frame to the plurality of STAs for acknowledgement. To further reduce overheads, as shown in FIG. 5b, an M-BA frame and a trigger frame are aggregated. However, even if some overheads of a physical layer preamble are reduced by using an aggregation mechanism, a problem of quite large overheads cannot be resolved yet.

Therefore, how to reduce overheads of an acknowledgement frame of a data packet including only dozens of bytes is a technical problem that needs to be resolved by a person skilled in the art.

### SUMMARY

This application provides an information indication method, an information acknowledgement method, and an apparatus, to reduce data overheads during replying with an acknowledgement frame. To resolve the technical problem, this application discloses the following technical solutions.

According to a first aspect, this application provides an information indication method. The method includes: sending, by an access point, a data frame to at least one station, where the data frame is a non-aggregated frame or an aggregated frame obtained by aggregating N MAC frames, N is a positive integer greater than 1 and is less than or equal to M, M is a positive integer, and M is a maximum allowable quantity of aggregated MAC frames; sending, by the access point, trigger information to the at least one station, where the trigger information is used to instruct the at least one station to reply with an acknowledgement frame on a shared resource unit; and receiving, by the access point, the acknowledgement frame fed back by the at least one station on the shared resource unit.

According to the method provided in this aspect of this application, the access point instructs, by sending the trigger information, the at least one station to feed back the acknowledgement frame on the shared resource unit. Replying with the acknowledgement frame by using the shared resource unit can reduce overheads for replying with acknowledgement frames for uplink and downlink data. In addition, a simple acknowledgement replying process is completed by flexibly using a reserved field of a frame in a standard or adding a negotiation process, and a redundant dedicated replying process is canceled, thereby reducing frame header overheads and an interval time, and increasing a data rate and a throughput.

Further, the trigger information includes at least one per station field, and each per station field correspondingly indicates one station or one group of stations. Each per station field includes at least one of the following information: a special station association identifier AID, a special modulation and coding scheme MCS, and special spatial stream allocation. In addition, an acknowledgement bitmap may be further used as a field of the trigger information and broadcast to a station that needs to receive the acknowledgement frame, to reduce overheads.

With reference to the first aspect, in a possible implementation, the sending, by the access point, the trigger information to the at least one station includes: sending, by the access point, the trigger information by broadcasting a trigger frame, sending the trigger information by sending a trigger frame in a unicast manner, or sending the trigger information by using an aggregation control field of the data frame.

With reference to the first aspect, in a possible implementation, the trigger information further includes a common area located behind a MAC frame header. The common area includes an optimized ACK indication field, and the optimized ACK indication field is used to instruct the access point to reply with the acknowledgement frame by carrying the acknowledgement bitmap in any one of the following manners: a non-optimized acknowledgement replying manner, a replying manner in which the acknowledgement bitmap is carried by using a field of a high efficient signal field B, and a replying manner in which the acknowledgement bitmap is carried by using a field of the trigger information.

With reference to the first aspect, in a possible implementation, at least one of the special station association identifier, the special modulation and coding scheme, and the special spatial stream allocation is used to indicate existence of the acknowledgement bitmap.

With reference to the first aspect, in a possible implementation, before the sending, by an access point, a data frame to at least one station, the method further includes: negotiating, by the access point, with the at least one station to determine a manner in which each station replies with the acknowledgement frame.

With reference to the first aspect, in a possible implementation, the negotiating, by the access point, with the at least one station to determine a manner in which each station replies with the acknowledgement frame includes: receiving, by the access point, an information element fed back by the at least one station, where the information element is used to indicate whether each station supports replying with the acknowledgement frame by using at least one of the shared resource unit and the acknowledgement bitmap; and determining, by the access point based on the information element, the manner in which each station replies with the acknowledgement frame.

With reference to the first aspect, in a possible implementation, the negotiating, by the access point, with the at least one station to determine a manner in which each station replies with the acknowledgement frame includes: negotiating, by the access point, with the at least one station by using a multiple user request-to-send MU-RTS frame and a simultaneous clear-to-send CTS frame, to determine the manner in which each station replies with the acknowledgement frame.

With reference to the first aspect, in a possible implementation, the trigger information further includes a common area located behind a MAC frame header. The common area includes an optimized ACK indication field, and the optimized ACK indication field is used to instruct the access point to reply with the acknowledgement frame by carrying the acknowledgement bitmap in any one of the following manners: a non-optimized acknowledgement replying manner, a replying manner in which the acknowledgement bitmap is carried by using a field of a high efficient signal field B, and a replying manner in which the acknowledgement bitmap is carried by using a field of the trigger information.

According to a second aspect, this application provides an information receiving method, including: receiving, by a station, a data frame and trigger information from an access point, where the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame on a shared resource unit; generating, by the station, the acknowledgement frame based on the data frame; and sending, by the station, the acknowledgement frame on the shared resource unit according to an instruction of the trigger information.

According to a third aspect, this application provides an information indication apparatus, including: a processing unit, configured to generate a data frame and trigger information, where the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct at least one station to reply with an acknowledgement frame on a shared resource unit; and a transceiver unit, configured to send the data frame and the trigger information to the at least one station, where the transceiver unit is further configured to receive the acknowledgement frame fed back by the at least one station on the shared resource unit.

According to a fourth aspect, this application provides an information receiving apparatus, including: a transceiver unit, configured to receive a data frame and trigger information, where the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame on a shared resource unit; and a processing unit, configured to generate the acknowledgement frame based on the data frame, where the transceiver unit is further configured to send the acknowledgement frame on the shared resource unit according to an instruction of the trigger information.

According to a fifth aspect, this application provides an access point, including a transceiver and a processor. The transceiver and the processor are configured to perform all or some of the method steps in the implementations of the first aspect.

According to a sixth aspect, this application provides at least one station, and each station includes a transceiver and a processor. The transceiver and the processor are configured to perform all or some of the method steps in the implementations of the second aspect.

According to a seventh aspect, this application further provides a computer storage medium. The computer storage medium may store a program. When the program is executed, all or some of the steps in the implementations of the information indication method and the information receiving method may be performed.

### BRIEF DESCRIPTION OF DRAWINGS

To describe the technical solutions in the embodiments of this application more clearly, the following briefly describes the accompanying drawings required for describing the embodiments.

FIG. 1 is a schematic diagram of a scenario in which an access point interacts with at least one station according to an embodiment of this application;

FIG. 2 is a schematic structural diagram of a packet in a multi-user format according to an embodiment of this application

FIG. 3 is a schematic structural diagram of a packet in a trigger based uplink format according to an embodiment of this application;

FIG. 4 is a schematic diagram of an acknowledgement process of downlink multi-user transmission according to an embodiment of this application;

FIG. 5a is a schematic diagram of an acknowledgement process of uplink multi-user transmission according to an embodiment of this application;

FIG. 5b is a schematic diagram of an acknowledgement process of uplink multi-user transmission in which M-BA and trigger frames are aggregated according to an embodiment of this application;

FIG. 6 is a schematic structural diagram of an ACK frame according to an embodiment of this application;

FIG. 7 is a schematic structural diagram of a BA frame according to an embodiment of this application;

FIG. 8 is a schematic structural diagram of a multi-TID BA frame according to an embodiment of this application;

FIG. 9 is a schematic structural diagram of an M-BA frame according to an embodiment of this application;

FIG. 10 is a schematic flowchart of an information indication method according to an embodiment of this application;

FIG. 11 is a schematic diagram of a manner of replying with an acknowledgement frame on a shared resource unit according to an embodiment of this application;

FIG. 12 is a schematic diagram of another manner of replying with an acknowledgement frame on a shared resource unit according to an embodiment of this application;

FIG. 13 is a schematic diagram of still another manner of replying with an acknowledgement frame on a shared resource unit according to an embodiment of this application;

FIG. 14 is a schematic structural diagram of a trigger frame including an AID according to an embodiment of this application;

FIG. 15 is a schematic diagram of replying with an acknowledgement frame by using a plurality of special shared resource units according to an embodiment of this application;

FIG. 16 is a schematic diagram of an acknowledgement frame replying manner in which an acknowledgement bitmap is used as a field of a trigger frame according to an embodiment of this application;

FIG. 17 is a schematic diagram of a trigger frame in which an acknowledgement bitmap is used as a field of the trigger frame according to an embodiment of this application;

FIG. 18 is a schematic diagram of an acknowledgement frame replying manner in which an acknowledgement bitmap is used as a field of an HE-SIG-B according to an embodiment of this application;

FIG. 19 is a schematic structural diagram of a HE-SIG-B in which an acknowledgement bitmap is used as a field according to an embodiment of this application;

FIG. 20 is a schematic diagram of an acknowledgement frame replying manner in which an acknowledgement bitmap is used as a field of an IoT-SIG according to an embodiment of this application;

FIG. 21 is a schematic diagram of exchanging, by using an information element, capability information of optimizing an acknowledgement replying manner according to an embodiment of this application;

FIG. 22 is a schematic structural diagram of an information indication apparatus according to an embodiment of this application;

FIG. 23 is a schematic structural diagram of an information receiving apparatus according to an embodiment of this application;

FIG. 24 is a schematic structural diagram of an access point according to an embodiment of this application; and

FIG. 25 is a schematic structural diagram of a station according to an embodiment of this application.

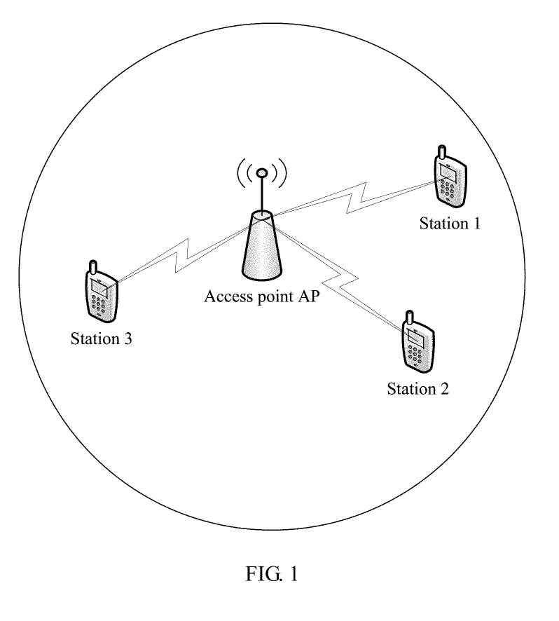

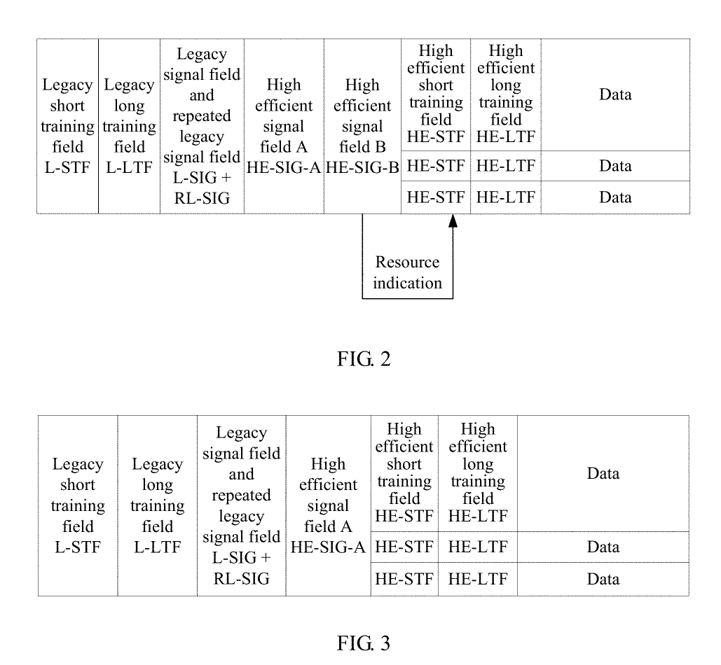

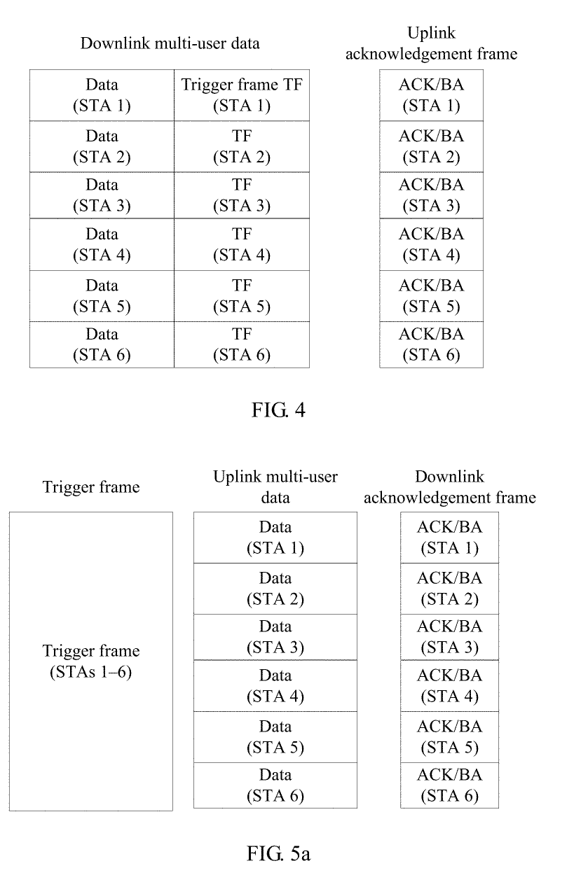

### DESCRIPTION OF EMBODIMENTS

A user acknowledgement solution provided in the embodiments of this application is applied to various Wi-Fi standard protocols, for example, 802.11a/g, 802.11n, 802.11ac, and 802.11ax, and is mainly applied to high-rate scenarios.

To facilitate subsequent description and clearly describe this application, the following first briefly describes terms that may be used in this application.

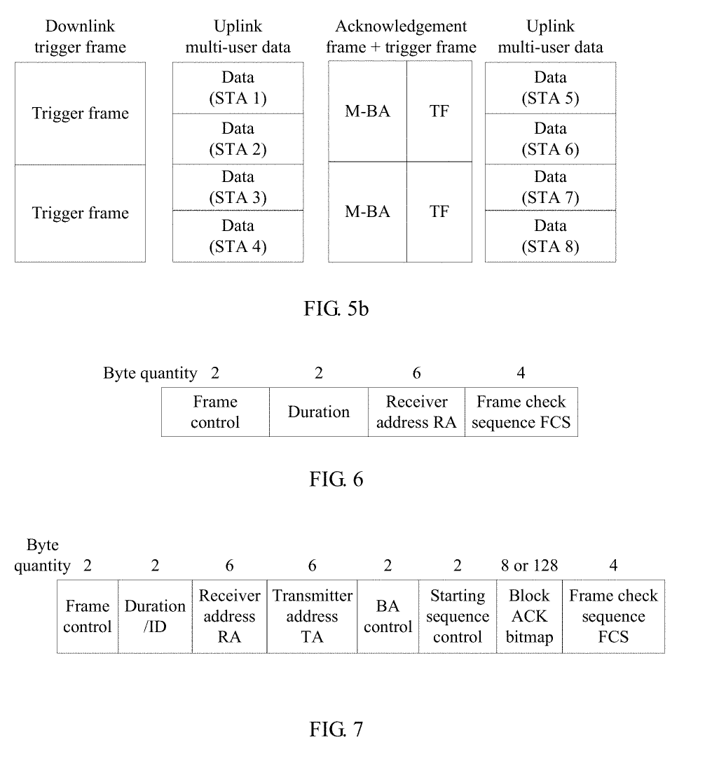

As specified in the 802.11 standard protocols, two types of common acknowledgement information are included. One is an ACK frame that is used for acknowledgement of data of a non-aggregated frame. The other is a BA frame that is used for acknowledgement of data of an aggregated frame, and therefore is referred to as block acknowledgement. Specifically, structures of the two frames are shown in FIG. 6 and FIG. 7.

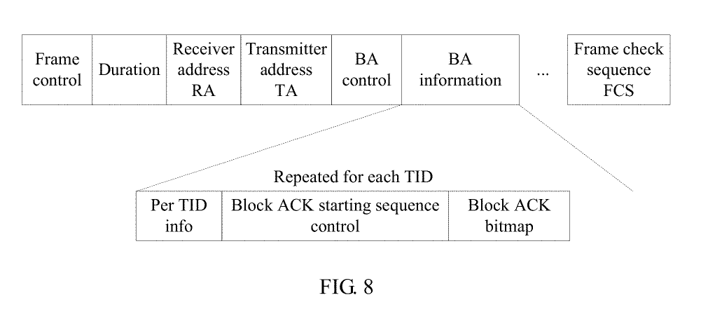

A multi-TID BA frame is further provided to reply with an acknowledgement frame for data of a plurality of traffic categories, and is used to perform block acknowledgement for the data of the plurality traffic categories simultaneously. For quality of service with different priorities, the 802.11e standard defines four access categories corresponding to traffic categories (traffic category, TC) with four priorities. The multi-TID BA frame is used to perform block acknowledgement for data of a plurality of traffic categories of a station simultaneously. A structure of the multi-TID BA frame is shown in FIG. 8.

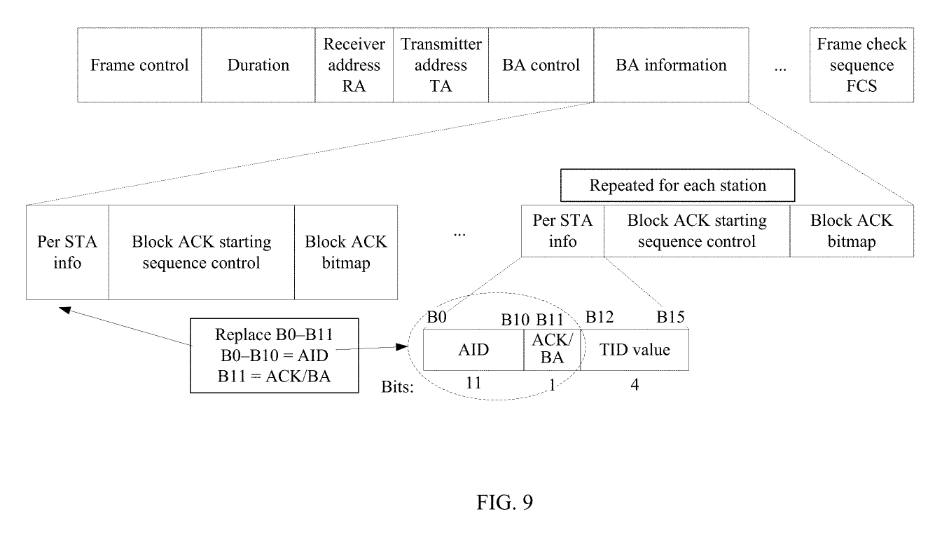

In a standard version, an M-BA frame is further provided. Based on the structure of the multi-TID BA frame, the M-BA frame is a multi-user block acknowledgement (multi-user block ACK, M-BA) frame. An access point may send one M-BA frame, to send acknowledgement or block acknowledgement information to a plurality of stations. FIG. 9 is a schematic structural diagram of an M-BA frame. The M-BA frame includes a BA information (BA information) field, and the BA information field is cascaded block acknowledgement information of the plurality of stations. A station association identifier (association identifier, AID) is placed in reserved bits (B0-B10) of Per TID Info, and is used to identify a station that needs to receive the acknowledgement information. An ACK/BA indication is placed in a reserved bit (B11) of Per TID Info, and is used to indicate whether the acknowledgement information sent to the station is ACK or BA. A main difference between the M-BA frame and the ACK/BA/multi-TID BA frame is that transmission of the ACK/BA acknowledgement information to the plurality stations is completed in one MAC frame. The M-BA frame is transmitted in a broadcast manner, and a receiver address (RA) is set to a broadcast address. When reading the M-BA frame, each station identifies, by searching for an AID, whether the access point sends the acknowledgement information to the station, and further identifies, by using the ACK/BA frame, whether acknowledgement or block acknowledgement is to be subsequently performed, thereby further reading subsequent different acknowledgement information.

A multi-user format and a trigger based uplink format are introduced in the embodiments of this application. The multi-user format is a format used when an access point performs downlink transmission with a plurality of stations. The trigger based uplink format is a format used when a plurality of stations simultaneously perform uplink multi-user transmission with an access point. The transmission includes data and any MAC frame such as a data frame or an acknowledgement frame.

In the uplink multi-user transmission, the access point first sends a trigger frame (Trigger Frame, TF) to the plurality of stations; after receiving the trigger frame, the plurality of stations perform uplink multi-user transmission based on resource scheduling information in the trigger frame; and then the access point replies to the plurality of stations with an acknowledgement frame based on received data of the plurality of stations.

An information indication method provided in this application may be applied to downlink multi-user transmission. The downlink multi-user transmission includes: sending, by an access point, a trigger frame and downlink data to a plurality of stations; and after receiving the trigger frame and the downlink data, replying, by each station, to the access point with an acknowledgement frame.

The access point (access point, AP) in the embodiments of this application may be a wireless access point (wireless access point, WAP). The station (station, STA) may also be referred to as a user. Further, the station or the user may include devices having a WLAN function, for example, a user terminal (user terminal, UT), a user agent (user agent, UA), a user device or user equipment (user equipment, UE), a cell phone (cell phone), a smartphone (smartphone), a personal computer, a tablet computer (tablet computer), a wearable device, a personal digital assistant (personal digital assistant, PDA), a mobile Internet device (mobile Internet device, MID), and an electronic book reader (e-book reader).

The embodiments provided in this application are specific for data including only dozens of bytes. The access point configures the data frame and the trigger information, so that the station reduces resource overheads when making an acknowledgement. Specific technical solutions are as follows:

### Embodiment 1

This embodiment is specific for optimizing an acknowledgement frame replying manner for downlink multi-user transmission. Specifically, the acknowledgement frame replying manner is optimized by sharing one resource unit (resource unit, RU), also referred to as one resource block, by a plurality of stations, to reduce resource overheads.

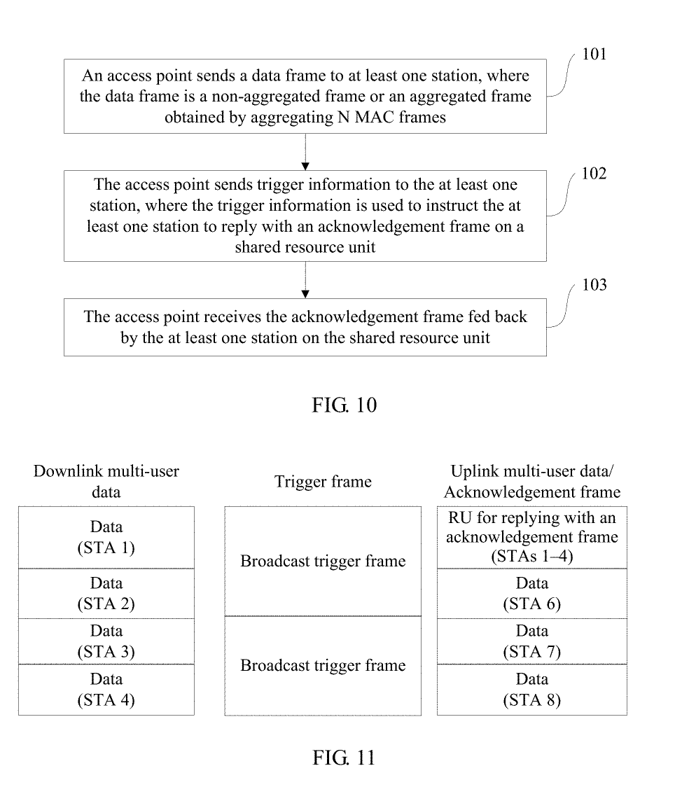

As shown in FIG. 10, this embodiment provides an information indication method. The method includes the following steps.

Step 101. An access point sends a data frame to at least one station, where the data frame is a non-aggregated frame or an aggregated frame obtained by aggregating N MAC frames, N is a positive integer greater than 1 and is less than or equal to M, M is a positive integer, and M is a maximum allowable quantity of aggregated MAC frames.

The non-aggregated frame includes only one MAC frame, and is not an aggregated MAC protocol data unit (aggregated MPDU, A-MPDU) obtained by aggregating two or more MAC frames. The non-aggregated frame includes a MAC protocol data unit (MAC protocol data unit, MPDU) or a single Media Access Control protocol data unit (single MPDU, S-MPDU). If the data frame is an aggregated frame obtained by aggregating N MAC frames, N is a positive integer greater than 1, and N<M, where M is a preset value. To be specific, a quantity of aggregated MAC frames in the aggregated frame is limited to no more than M, where M is the maximum allowable quantity of aggregated MAC frames. Herein, the limitation that N does not exceed M is intended to limit N to be in a relatively small range, so as to reduce overheads of an acknowledgement frame. Specifically, a value of N may be preset, may be determined through negotiation between the access point and the station, or may be directly set by the access point. Optionally, assuming that M is 4, it indicates that N is less than or equal to 4 and N is 2, 3, or 4.

Step 102. The access point sends trigger information to the at least one station, where the trigger information is used to instruct the at least one station to reply with an acknowledgement frame by using a shared resource unit.

The trigger information may be sent by using a trigger frame. Optionally, the access point may separately send the data frame and the trigger frame, or the access point sends the data frame and the trigger frame simultaneously. After sending the data frame, the access point sends the trigger frame to a destination station to trigger downlink data, so that the destination station replies with an acknowledgement frame. In addition, the access point may also trigger other stations simultaneously to perform uplink multi-user transmission.

Step 103. The access point receives the acknowledgement frame fed back by the at least one station on the shared resource unit.

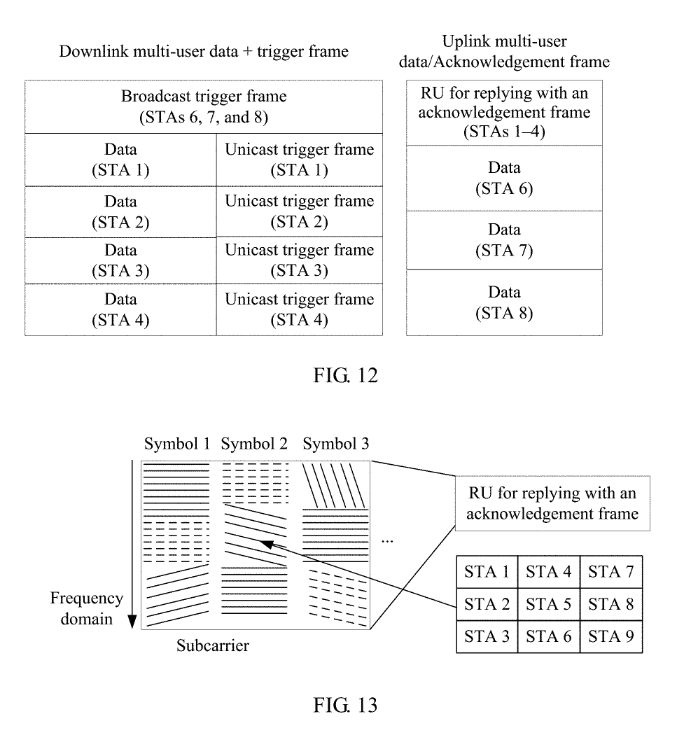

Further, in a process of sending the trigger frame, as shown in FIG. 11 and FIG. 12, the access point may send the trigger frame in a broadcast manner, or may send the trigger frame simultaneously while sending data. A specific manner of sending the data frame and the trigger frame is not limited.

As shown in FIG. 11, when the access point sends the trigger frame in the broadcast manner, a specific process of the information indication method is: First, the access point sends downlink multi-user data, for example, the data frame, to a station 1 to a station 4, and then the access point broadcasts the trigger frame to all the stations, where the broadcast trigger frame is used to instruct the station 1 to the station 4 to reply with acknowledgement frames on the shared resource unit. After receiving the broadcast trigger frame, the station 1 to the station 4 reply to the access point with the acknowledgement frames on the shared resource unit according to an instruction of the broadcast trigger frame.

A plurality of stations may reply with acknowledgement frames on the shared resource unit in different manners. In a possible replying manner, if the data or data frame sent by the access point is a non-aggregated frame, because the non-aggregated frame has only one MAC frame or MPDU, only one bit is needed to reply whether the data of the access point is correctly received. Specifically, a process of replying to the access point with the acknowledgement frame by using one bit is as follows:

In a manner, the station sends the acknowledgement frame in a code division manner. The code division manner includes multiplying, by a different preset orthogonal sequence, information sent by each station, to avoid a mutual transmission conflict when the plurality of stations reply with the acknowledgement frames on the shared resource unit simultaneously. The preset orthogonal sequence may be a sequence in time domain or a sequence in frequency domain, and may further use a Walsh code, a Zadoff-Chu sequence, or a pseudonoise (pseudorandom noise, PN) sequence, where each sequence is corresponding to an acknowledgement frame or acknowledgement information of a station.

In another manner, an acknowledgement frame or acknowledgement information of each station is replied with and carried by using one or more subcarriers, and acknowledgement frames or acknowledgement information of different stations is differentiated by using different symbols or different subcarriers. For example, each station uses one bit to reply with the acknowledgement frame or the acknowledgement information on the shared resource unit. To ensure information replying robustness, a code word may be further used to perform spectrum spreading processing on a sequence.

FIG. 13 is a schematic diagram of a manner of replying with an acknowledgement frame on a shared resource unit. A symbol 1 indicates a symbol on a subcarrier of the shared resource unit, and each symbol may be used to reply with the acknowledgement frame. Optionally, the symbol 1 may start from a first symbol of an HE-LTF, or may start from a first symbol of a load part. If the HE-LTF has a relatively large quantity of symbols, the acknowledgement frame may be replied with by using only the HE-LTF. The symbol 1 to a symbol 3 form a shared resource unit, and the shared resource unit is used to indicate a location of a shared resource unit on which a station 1 to a station 9 reply with acknowledgement frames. In addition, each station may reply with the acknowledgement frame by using several subcarriers of one symbol on the shared resource unit or by using one spatial stream.

If the data frame sent by the access point is an aggregated frame, because the maximum quantity of aggregated frames is limited to no more than M, for example, 2, each station is instructed to reply with the acknowledgement frame by using 2-bit information. This is equivalent to that, in a non-aggregated frame-based acknowledgement manner, acknowledgement frames of two stations are allocated to one station to complete acknowledgement frame replying in an aggregated case.

Further, the shared resource unit may be a fixed resource unit, for example, a fixed first resource unit; or one or more shared resource units may be indicated by using the trigger frame, to reply with the acknowledgement frame.

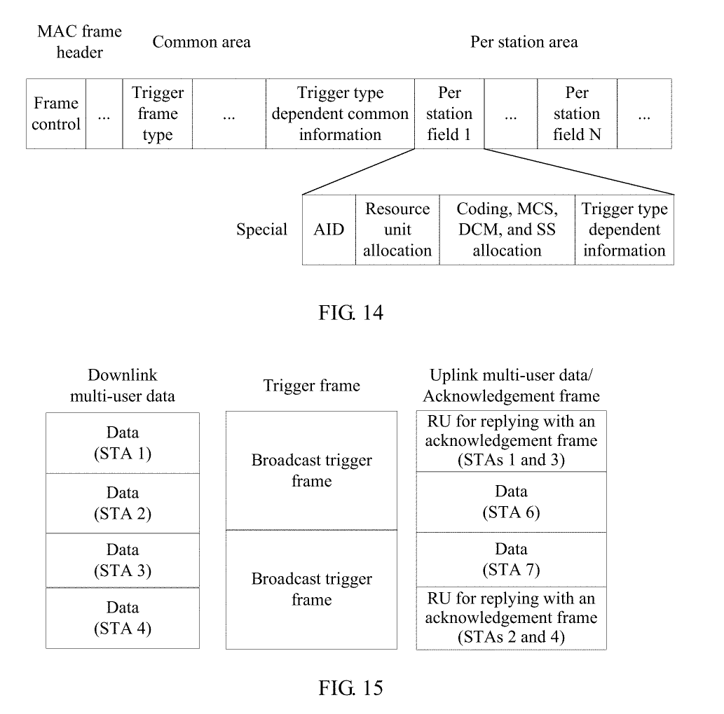

Specifically, the access point instructs, by broadcasting the trigger frame, the at least one station to reply with the acknowledgement frame on the shared resource unit. As shown in FIG. 14, the trigger frame includes a MAC frame header, a common area, and a per station area. The per station area includes several per station fields, for example, a per station field 1, a per station field 2, . . . , and a per station field N, where N is corresponding to a quantity of stations to which the trigger frame needs to be sent. Each per station field may include at least one of the following information fields: a special station association identifier (association identifier, AID), a special modulation and coding scheme (modulation and coding scheme, MCS), and special spatial stream allocation (spatial stream allocation, SS Allocation). These fields are used to indicate that the per station field is used to indicate the acknowledgement information of the shared resource unit. When the AID field, the MCS field, or the special spatial stream allocation field exists, the per station field further includes a resource unit allocation field. The resource unit allocation field is used to indicate a shared resource unit on which a station at a receive end sends an acknowledgement frame. In addition, the per station field further includes fields such as a non-special station association identifier, a non-special modulation and coding scheme, and non-special spatial stream allocation.

For example, when configuring the trigger information or the trigger frame, the access point selects one from reserved AIDs (from 2008 to 2045). When receiving the trigger frame and detecting that the trigger frame includes the selected AID, a station determines that the station needs to reply with an acknowledgement frame by using the shared resource unit. Optionally, the resource unit allocation field behind the AID is further used to instruct to reply with the acknowledgement frame on the shared resource unit configured by the access point. Alternatively, if the resource unit allocation field still includes many reserved (reserved) entries, one or more reserved entries may be used to indicate a resource unit that is used as the shared resource unit for replying with the acknowledgement frame. Alternatively, at present, only MCSs 0 to 11 are allocated and used, and MCSs 12 to 15 are not used yet. Alternatively, if an index table of the special spatial stream allocation includes many reserved entries, these reserved entries may be used to instruct the station to reply with the acknowledgement frame by using the shared resource unit. Likewise, optionally, the resource unit allocation field behind the AID is further used to indicate a location of the shared resource unit on which the at least one station replies with the acknowledgement frame.

In addition, the access point may further add indication information to the trigger information or the data frame, where the indication information is used to indicate an order of replying with the acknowledgement frame by the at least one station on the shared resource unit. For example, if the trigger frame is used for indication, an AID may be used to indicate a real AID of a station, special resource unit allocation is used to indicate a shared resource unit on which the station needs to reply with acknowledgement information, and then an MCS or SS Allocation is used to indicate an order of replying with the acknowledgement information by the STA. In the indication method of using the trigger frame to carry the indication information, the data frame may not be changed, and only an existing trigger frame structure is used to indicate a shared resource block for replying with the acknowledgement information/acknowledgement frame. If the data frame is used to indicate the order of replying with the acknowledgement frames, in the subsequent trigger frame, the access point needs to use only the special AID to instruct all STAs in a resource unit to reply with the acknowledgement information on the shared resource unit.

Alternatively, the trigger information further includes the resource unit allocation field. The resource unit allocation field is used to indicate locations at which different stations reply with acknowledgement frames/acknowledgement information in the shared resource unit; or the at least one station may reply with the acknowledgement frame in an order indicated by an HE-SIG-B in a downlink multi-user packet, to avoid separately indicating an order of replying with the acknowledgement frame by each station. As shown in FIG. 14, in a manner of replying with the acknowledgement frame by using a plurality of shared resource units, the resource unit allocation field corresponding to the special AID is used to indicate locations at which the station 1 to the station 4 reply with the acknowledgement frames, for example, a first shared resource unit on which the station 1 and a station 3 reply with acknowledgement frames and a second shared resource unit on which a station 2 and the station 4 reply with acknowledgement frames.

It should be noted that the order described in this embodiment is not an order of replying with acknowledgement frames by stations, but may be understood as an order of code elements of an orthogonal code. For example, all stations send the acknowledgement frames simultaneously, but these acknowledgement frames are a mutually orthogonal sequence. There is a one-to-one correspondence between sequences, codes, or the like that are configured by the access point and all stations at the receive end.

For a manner in which the access point sends the trigger frame in a unicast manner, the unicast trigger frame includes trigger information of a single station. Similar to the broadcast trigger frame, the unicast trigger frame may also use a special AID, a special MCS, or special spatial stream allocation to indicate that the per station field is used to indicate the acknowledgement information of the shared resource unit. In addition, the trigger information is sent in the unicast manner, and indication information does not affect another station. Therefore, information such as an order of replying with an acknowledgement frame by the station and a location of a shared resource unit on which the station replies with the acknowledgement frame may be indicated by redefining the trigger information of an optimized acknowledgement mechanism by using a new control ID in a high efficient aggregated control (high efficient aggregated control, HE-A-control) field at a MAC frame header, or may be indicated by redefining a frame format of the unicast trigger frame.

In addition, the acknowledgement frame described in this embodiment of this application may be positive acknowledgement ACK information, may be negative acknowledgement NACK information, or may be other acknowledgement information of the station.

According to the information indication method provided in this embodiment, the access point first configures and sends the data frame, and then instructs, by using the trigger frame carrying the indication information, the plurality of stations to reply with the acknowledgement frame by using the shared resource unit, thereby optimizing a downlink data acknowledgement replying manner. A reserved field such as the AID or the MCS in the trigger frame is used to improve flexibility of configuration indication, thereby canceling a redundant dedicated replying process. Only the orthogonal code is used to complete replying of acknowledgement information of the plurality of stations by using one shared resource unit, thereby reducing frame header overheads and an interval time, and increasing a data rate and a throughput.

### Embodiment 2

This embodiment is specific for optimizing an acknowledgement frame replying manner for uplink multi-user transmission, especially for the manner of aggregating M-BA and trigger frames that is described in the background. For a problem that overheads are still very large for data that has only dozens of bytes, a solution provided in this embodiment is: embedding acknowledgement information or an acknowledgement frame into a trigger frame, to be specific, using the compressed acknowledgement information as a field of the trigger frame and broadcasting the trigger frame to a plurality of stations that need to receive the acknowledgement frame.

Similar to that in Embodiment 1, it is agreed in this embodiment that a data frame is a non-aggregated frame or an aggregated frame in which a quantity of aggregated MAC frames does not exceed M, where M is a relatively small value, for example, 2, 3, or 4. Therefore, if there are N stations that need to receive acknowledgement information, only M*N bits are needed to carry acknowledgement information/acknowledgement frames of the N stations. For example, each station previously transmits a non-aggregated frame. If there are a total of N stations, only one N-bit acknowledgement bitmap needs to be transmitted, and each bit is corresponding to a receiving status of previous data transmission.

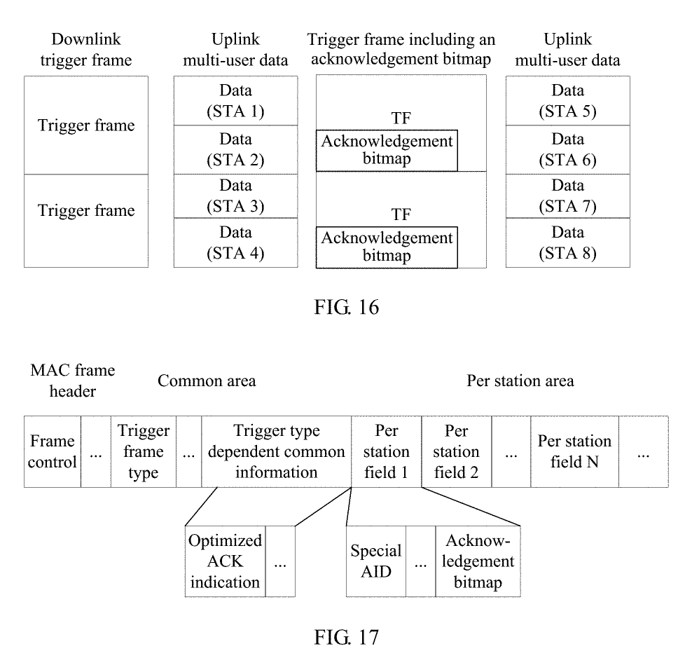

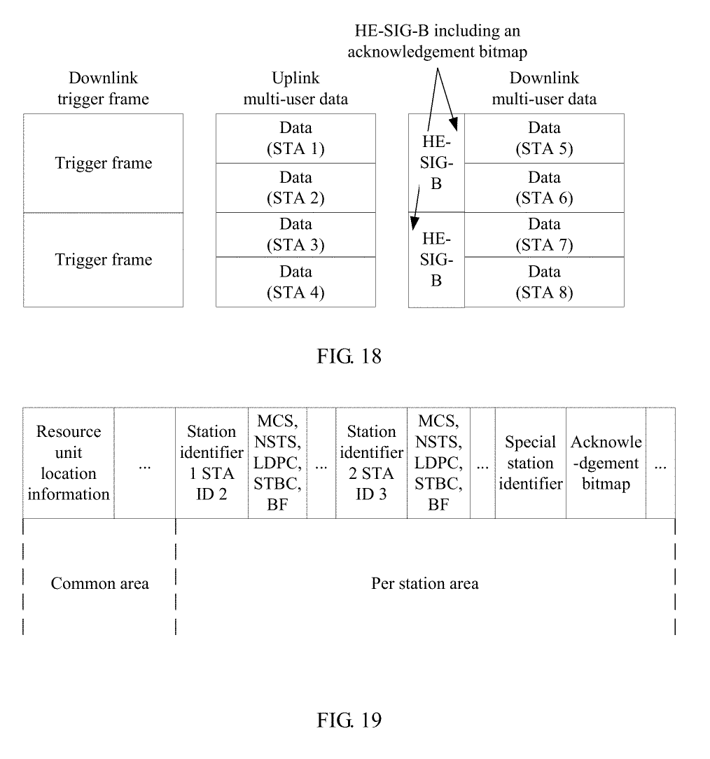

In this embodiment, an acknowledgement bitmap is used as a field of a trigger frame to reply with an acknowledgement frame. The acknowledgement bitmap is used to indicate whether the access point correctly receives, in previous uplink multi-user transmission, data sent by the at least one station. As shown in FIG. 16, during data transmission between the access point and a plurality of stations, the access point first sends a downlink trigger frame to the at least one station (a station 1 to a station 3), to trigger the station 1 to the station 4 to send uplink multi-user data. After receiving the uplink multi-user data, the access point broadcasts a trigger frame to all the stations. The broadcast trigger frame includes an acknowledgement bitmap, and the acknowledgement bitmap is used to feed back acknowledgement frames to the station 1 to the station 4, and trigger other stations (a station 5 to a station 8) to reply with acknowledgement frames. An order of each station in the acknowledgement bitmap/acknowledgement bits may be the same as an original occurrence order of scheduling information used to trigger uplink data transmission in a trigger frame, or may be indicated during transmission of trigger information. The following provides specific description with reference to a frame structure of the trigger frame.

FIG. 17 is a schematic structural diagram of a trigger frame in which an acknowledgement bitmap is used as a field of the trigger frame. The trigger frame includes a MAC frame header, a common area, a per station area, and the like. Trigger type dependent common information in the common area includes an optimized ACK indication field. The optimized ACK indication field is used to indicate whether to reply with acknowledgement information of subsequent uplink data in an acknowledgement frame replying manner in which the acknowledgement bitmap is used as the field of the trigger frame. Optionally, the acknowledgement bitmap may be carried in a per station field, or may be carried in the trigger type dependent common information field in the common area.

Further, information indicating whether information in the per station field in a fixed location is the acknowledgement bitmap may be added to the common area; or a special AID, a special MCS, and special spatial stream allocation in the per station field may be used to indicate that the acknowledgement bitmap exists in the per station field, where the acknowledgement bitmap is used to acknowledge previous uplink transmission.

In this embodiment, the access point embeds the acknowledgement bitmap into the trigger frame, so that the access point replies with the acknowledgement frame simultaneously while sending the trigger frame. This prevents the access point from separately sending an acknowledgement frame to a station, and reduces overheads for sending the acknowledgement frame.

### Embodiment 3

Based on Embodiment 2, this embodiment further optimizes the acknowledgement frame replying for uplink multi-user data transmission. To further reduce overheads, in this embodiment, an acknowledgement bitmap used as a field of an HE-SIG-B is replied as an acknowledgement frame.

Specifically, the method includes: sending, by an access point, a trigger frame to at least one station; after receiving the trigger frame sent by the access point, sending, by the station such as a station 1 to a station 4, uplink multi-user data to the access point; and receiving, by the access point, the data, and replying to the corresponding station with an acknowledgement bitmap in an acknowledgement frame replying manner in which the acknowledgement bitmap is used as a field of an HE-SIG-B. FIG. 19 is a schematic structural diagram of an HE-SIG-B in which an acknowledgement bitmap is used as a field of the HE-SIG-B.

Generally, a frame exchange flowchart does not include a physical layer preamble. In this embodiment, the schematic structural diagram of the HE-SIG-B shown in FIG. 19 includes the acknowledgement bitmap and special station identifiers such as a special AID, a special MCS, and special spatial stream allocation.

With reference to a format of the HE-SIG-B, the following describes the acknowledgement frame replying manner provided in this embodiment. As shown in FIG. 19, similar to a structure of the trigger frame, a structure of the HE-SIG-B includes a common area and a per station area. The acknowledgement bitmap may be used as a field of the common area. Alternatively, similar to the trigger frame, the special AID, the special MCS, or the special spatial stream allocation may be used to indicate that the per station field indicates the acknowledgement bitmap.

If the acknowledgement bitmap is carried in the per station area, the acknowledgement bitmap is configured at the end of the per station area. In the HE-SIG-B, resource unit location information is indicated in the common area, and the following per station area is also indicated according to a resource unit order. Therefore, in order not to affect order indication, the special station identifiers and the acknowledgement bitmap are placed at the end of the per station area.

In addition, in this embodiment and Embodiment 2, an optimized ACK indication field shown in FIG. 17 may be used to further indicate whether to carry, after uplink multi-user data transmission, the acknowledgement bitmap by using the subsequent trigger frame or the HE-SIG-B. For example, the optimized ACK indication field includes two bits, and the two bits can indicate the following four cases:

when the two bits are 00, it indicates that an existing non-optimized acknowledgement replying manner is subsequently used;

when the two bits are 01, it indicates that a replying manner in which a field of the HE-SIG-B carries the acknowledgement bitmap is subsequently used;

when the two bits are 10, it indicates that a replying manner in which a field of the trigger frame carries the acknowledgement bitmap is subsequently used; and

when the two bits are 11, it indicates a reserved entry used to indicate other information.

The foregoing is only an example of the optimized ACK indication field. A different order may alternatively be used for the field. For example, 00 indicates that a replying manner in which a field of the HE-SIG-B carries the acknowledgement bitmap is subsequently used, and 01 indicates that an existing non-optimized acknowledgement replying manner is subsequently used. The field may alternatively include a different quantity of bits. For example, only one bit is used. In this case, 0 indicates that an existing non-optimized acknowledgement replying manner is subsequently used, and 1 indicates that a replying manner in which a field of the HE-SIG-B or the trigger frame carries the acknowledgement bitmap is subsequently used. Alternatively, more bits are used. In addition to one or more of the foregoing several cases, other cases are further included. Alternatively, more reserved entries are available. This is not limited in this application.

For the acknowledgement bitmap in Embodiment 2 and Embodiment 3, a length of the acknowledgement bitmap may be determined based on a maximum allowable quantity N of stations and a maximum quantity M of supported aggregated frames. Bits of a fixed maximum value M*N are used for transmission. A pattern of a bitmap, to be specific, N and M, may also be indicated in front of the bitmap, to indicate a variable bitmap.

Physical bandwidth carried by the HE-SIG-B may be 20 MHz. However, bandwidth supported by some IoT STAB may be less than 20 MHz. For example, the bandwidth may be only 2 MHz. Therefore, these stations may be incapable of understanding the HE-SIG-B. In this case, it may be considered that the acknowledgement bitmap is carried by using both the HE-SIG-B and an IoT-SIG or is carried directly by using an IoT-SIG

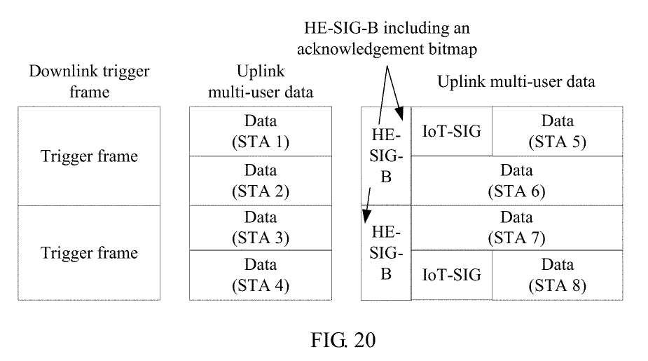

As shown in FIG. 20, an acknowledgement frame replying manner in which the acknowledgement bitmap is used as a field of the IoT-SIG is provided. In addition to the HE-SIG-B field and the IoT-SIG field, the physical layer preamble further includes an HE-STF and an HE-LTF, and may further include an IoT-STF and an IoT-LTF. In FIG. 20, because a MAC frame exchange process is related and only acknowledgement bitmap information in SIG is concerned, the HE-STF, the HE-LTF, IoT-STF, and the IoT-LTF are not shown.

According to the method provided in this embodiment, the acknowledgement bitmap is configured in the HE-SIG-B field, to reply with the acknowledgement frame. This further reduces overheads for replying with the acknowledgement frame in uplink multi-user transmission.

### Embodiment 4

Based on Embodiment 1, Embodiment 2, and Embodiment 3, this embodiment further introduces an acknowledgement optimization negotiation mechanism, to improve efficiency of transmission between an access point and a station and reduce air interface overheads. In addition, the negotiation mechanism is used to determine a manner in which the access point replies with an acknowledgement frame and trigger information, and indicate a shared resource unit on which a plurality of stations reply with acknowledgement frames. The negotiation process may be performed in an acknowledgement process of downlink multi-user transmission and an acknowledgement process of uplink multi-user transmission. Specifically, the negotiation mechanism includes the following manners:

In manner 1, a static negotiation manner is used.

When being associated with the access point, the station negotiates with the access point about whether to support an optimized/simplified acknowledgement frame replying manner. Further, negotiated content includes whether to support only the optimized acknowledgement replying manner or simultaneously support an existing acknowledgement replying manner and the optimized acknowledgement replying manner when the station exchanges data with the access point. In specific implementation, an information element (information element, IE) of a response is carried in one or more of a beacon frame, an association request frame, an association response frame, a re-association request frame, a probe request frame, and a probe response frame, to indicate whether to support the optimized acknowledgement replying manner, and a specific optimized acknowledgement replying manner that is supported.

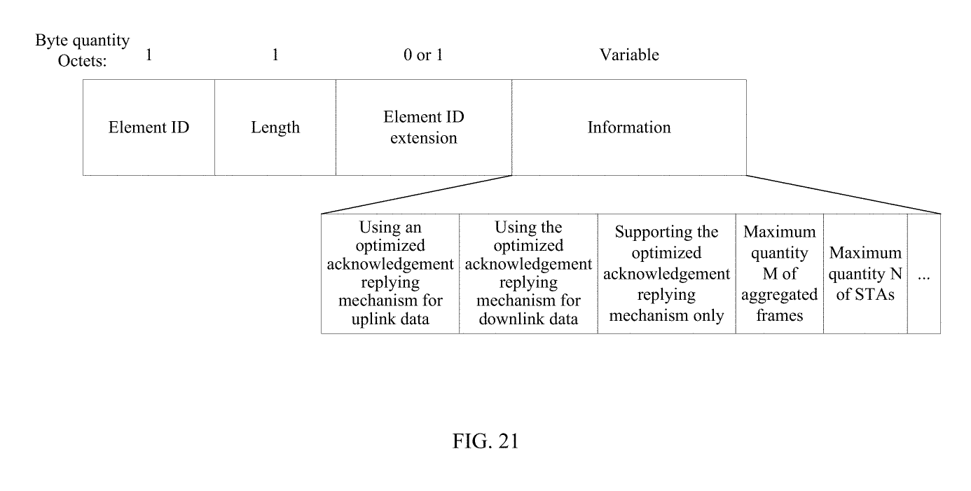

FIG. 21 is a schematic diagram of exchanging, by using an IE, capability information of optimizing an acknowledgement replying manner. An information (information) field includes at least one of the following indication information:

using the optimized acknowledgement replying mechanism for uplink data, using the optimized acknowledgement replying mechanism for downlink data, supporting the optimized acknowledgement replying mechanism only, a maximum quantity M of aggregated frames, a maximum quantity N of stations, and the like.

In addition, different information fields behind element identifier extensions (element ID extension) may be further used to carry different indication information or management information.

In manner 2, a relatively flexible negotiation manner is used.

The access point negotiates with the at least one station by using a multi-user request-to-send (multiple user request to send, MU-RTS) frame and a simultaneous clear-to-send (clear to send, CTS) frame. Specifically, during multi-user data transmission, the access point usually needs to exchange the MU-RTS frame and the simultaneous CTS frame with a plurality of stations to reserve a transmission opportunity for transmitting data, to ensure that the data is not interfered with by another access point and station. Therefore, whether to use the optimized acknowledgement frame replying mechanism may be determined by exchanging the MU-RTS frame and the simultaneous CTS frame.

For example, if the access point subsequently wants to perform data transmission at a relatively high speed and does not want to limit a quantity of aggregated data, the access point may instruct to use an existing data transmission and replying mechanism. If the access point subsequently wants to exchange a relatively small amount of data with an IoT STA, the access point may instruct the station to use the optimized acknowledgement replying mechanism.

In manner 3, no negotiation is performed, and an optimized ACK indication field in a trigger frame or a data frame is used to indicate whether to use the optimized acknowledgement replying mechanism after each data transmission.

When the acknowledgement replying mechanism is used, the access point sends the data based on a limited maximum quantity M of aggregated frames when exchanging data with the station. A length of an acknowledgement bitmap or acknowledgement bits, or the like is determined based on the maximum quantity M of aggregated frames and the maximum quantity N of stations supported by the access point.

In this embodiment, the negotiation mechanism is introduced, when sending the data frame and the trigger frame to the station, the access point can determine, based on a status of the station, to use which acknowledgement frame replying manner, for example, the optimized/simplified acknowledgement frame replying manner. This implements a simple acknowledgement replying process, cancels a redundant dedicated replying process, reduces frame header overheads and an interval time, and increases a data rate and a throughput.

### Embodiment 5

This embodiment provides an information receiving method that is corresponding to Embodiment 1 to Embodiment 3 and is used to: receive a data frame and trigger information that are sent by an access point, and reply with an acknowledgement frame. Specifically, the information receiving method includes the following steps:

Step 201. A station receives the data frame and the trigger information from the access point, where the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame on a shared resource unit.

Step 202. The station generates the acknowledgement frame based on the data frame.

Step 203. The station sends the acknowledgement frame on the shared resource unit according to an instruction of the trigger information, where the acknowledgement frame may be positive acknowledgement ACK information, may be negative acknowledgement NACK information, or may be other acknowledgement information of the station.

Optionally, the sending, by the station, the acknowledgement frame on the shared resource unit according to an instruction of the trigger information includes: if the data frame is a non-aggregated frame, sending, by the station, the acknowledgement frame by using a preset bit, for example, one bit; or sending, by the station, the acknowledgement frame on the shared resource unit in a code division manner. Alternatively, the sending the acknowledgement frame on the shared resource unit in a code division manner includes: sending, by the station, the acknowledgement frame by using a preset orthogonal sequence, where the preset orthogonal sequence includes a Zadoff-Chu sequence, a PN sequence, or a Walsh code.

Optionally, the sending, by the station, the acknowledgement frame by using a byte including a preset quantity of bits, for example, a one-bit byte includes: performing, by the station, spectrum spreading processing on the sequence by using a code word.

Optionally, the acknowledgement frame includes an acknowledgement bitmap. The acknowledgement bitmap is located in a common area or a per station area. The acknowledgement bitmap is used to indicate whether the access point correctly receives, in previous uplink multi-user transmission, data sent by the at least one station.

Optionally, the acknowledgement frame includes an HE-SIG-B and an IoT-SIG The IoT-SIG is located behind the HE-SIG-B and is used to carry the acknowledgement bitmap.

According to the information receiving method provided in this embodiment, for a data packet including only dozens of bytes, simplified acknowledgement replying manners are proposed for uplink and downlink data, and a simple acknowledgement replying process is completed by flexibly using a reserved field of a frame in a standard or adding a negotiation process. This cancels a redundant dedicated replying process, reduces frame header overheads and an interval time, and increases a data rate and a throughput.

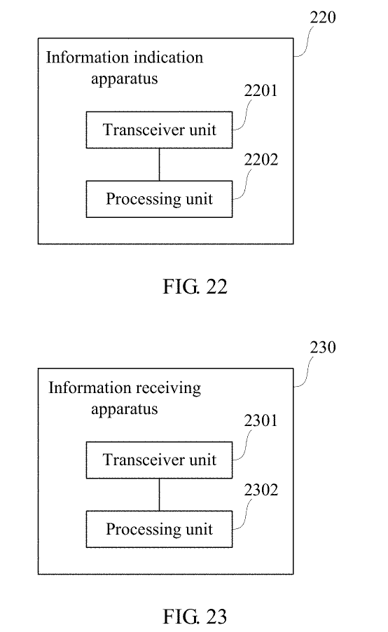

As shown in FIG. 22, an embodiment further provides an information indication apparatus. The apparatus is configured to perform the steps of the information indication method shown in FIG. 10 and the method processes described in Embodiment 1 to Embodiment 4.

The apparatus includes a transceiver unit 2201 and a processing unit 2202. The processing unit 2202 is configured to generate a data frame and trigger information, where the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct at least one station to reply with an acknowledgement frame on a shared resource unit.

The transceiver unit 2201 is configured to: send the data frame and the trigger information to the at least one station, and receive the acknowledgement frame fed back by the at least one station on the shared resource unit.

Optionally, the trigger information includes at least one per station field, and each per station field correspondingly indicates one station or one group of stations. Each per station field includes at least one of the following information: a special station association identifier AID, a special modulation and coding scheme MCS, and special spatial stream allocation. The special AID, the special MCS, and the special spatial stream allocation are further used to indicate existence of the acknowledgement bitmap.

In addition, the per station field further includes resource unit allocation, and the resource unit allocation is used to indicate a location of the shared resource unit on which the at least one station feeds back the acknowledgement frame.

Optionally, the trigger information is further used to instruct the at least one station to send the acknowledgement frame in a code division manner, the code division manner includes multiplying, by a different preset orthogonal sequence, information sent by each station, and the preset orthogonal sequence includes a Zadoff-Chu sequence, a pseudonoise PN sequence, or a Walsh code.

Optionally, the transceiver unit 2201 is specifically configured to: send the trigger information by broadcasting a trigger frame; or send the trigger information by sending a trigger frame in a unicast manner; or send the trigger information by using an aggregation control field of the data frame.

Optionally, the trigger information further includes a common area located behind a MAC frame header. The common area carries an optimized ACK indication field. The optimized ACK indication field is used to indicate whether to reply, when the at least one station re-sends the acknowledgement frame, with the acknowledgement frame in a manner in which the acknowledgement bitmap is used as a field of the trigger information.

Optionally, the trigger information further includes the acknowledgement bitmap, and the acknowledgement bitmap is used to indicate whether the access point correctly receives, in previous uplink multi-user transmission, data sent by the at least one station.

Optionally, the acknowledgement bitmap is carried by using a field in the trigger information or a field in a high efficient signal field B, where the field includes a field in the common area or a per station area of the trigger information, or a field in a common area or a per station area of the high efficient signal field B.

Optionally, the optimized ACK indication field is further used to instruct the access point to reply with the acknowledgement frame by carrying the acknowledgement bitmap in any one of the following manners: a non-optimized acknowledgement replying manner, a replying manner in which a field of the high efficient signal field B is used to carry the acknowledgement bitmap, and a replying manner in which a field of the trigger information is used to carry the acknowledgement bitmap.

Optionally, the transceiver unit 2201 is further configured to determine, through negotiation with the at least one station, a manner in which each station replies with the acknowledgement frame. Alternatively, the access point determines, according to an instruction of the trigger information or the data frame, a manner in which each station replies with the acknowledgement frame.

Further, that the transceiver unit 2201 determines, through negotiation with the at least one station, a manner in which each station replies with the acknowledgement frame includes: determining, by receiving an information element fed back by the at least one station, the manner of replying with the acknowledgement frame, where the information element is used to indicate whether each station itself supports an optimized acknowledgement replying manner; or determining, through negotiation with the at least one station by using a multi-user request-to-send MU-RTS frame and a simultaneous clear-to-send CTS frame, the manner in which each station replies with the acknowledgement frame.

As shown in FIG. 23, an embodiment further provides an acknowledgement frame acknowledgement apparatus, configured to: receive trigger information and a data frame that are sent by an acknowledgement frame indication apparatus, and perform the method processes described in Embodiment 1 to Embodiment 4.

The apparatus includes a transceiver unit 2301 and a processing unit 2302. The transceiver unit 2301 is configured to receive a data frame and trigger information from an access point, where the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame by using a shared resource unit. The processing unit 2302 is configured to generate the acknowledgement frame based on the data frame.

The transceiver unit 2301 is further configured to send the acknowledgement frame on the shared resource unit according to an instruction of the trigger information.

The trigger information includes at least one per station field, and each per station field correspondingly indicates one station or one group of stations. Each per station field includes at least one of the following information: a special station association identifier AID, a special modulation and coding scheme MCS, and special spatial stream allocation.

Optionally, the transceiver unit 2301 is further configured to: if the data frame is a non-aggregated frame, send, by the station, the acknowledgement frame by using a preset bit.

Optionally, the transceiver unit 2301 is further configured to: send the acknowledgement frame by using a preset orthogonal sequence, where the preset orthogonal sequence includes a Zadoff-Chu, a PN sequence, or a Walsh code; or perform spectrum spreading processing on the sequence by using a code word.

Optionally, the acknowledgement frame includes an acknowledgement bitmap. The acknowledgement bitmap is used to indicate whether the access point correctly receives, in previous uplink multi-user transmission, data sent by the at least one station, and the acknowledgement bitmap is located in a common area or a per station area.

The trigger information further includes a common area located behind a MAC frame header. The common area includes an optimized ACK indication field. The optimized ACK indication field is used to instruct the access point to reply with the acknowledgement frame by carrying the acknowledgement bitmap in any one of the following manners:

a non-optimized acknowledgement replying manner, where the non-optimized acknowledgement replying manner is a manner used in the prior art, for example, an M-BA frame replying manner, and another replying manner different from the replying manner, provided in this embodiment of this application, in which the shared resource unit and the acknowledgement bitmap are used;

a replying manner in which the acknowledgement bitmap is carried by using a field of a high efficient signal field B; and

a replying manner in which the acknowledgement bitmap is carried by using a field of the trigger information.

In addition, the station is further configured to negotiate with the access point before replying with the acknowledgement frame, to determine a manner of replying with the acknowledgement frame.

Optionally, the acknowledgement frame includes the high efficient signal field B, an HE-SIG-B, and an Internet of Things signaling field IoT-SIG located behind the HE-SIG-B. The HE-SIG-B is used to carry the acknowledgement bitmap.

In another embodiment, an access point is further provided. As shown in FIG. 23, the access point may be the information indication apparatus in the foregoing embodiments, and is configured to implement the method steps in the foregoing embodiments.

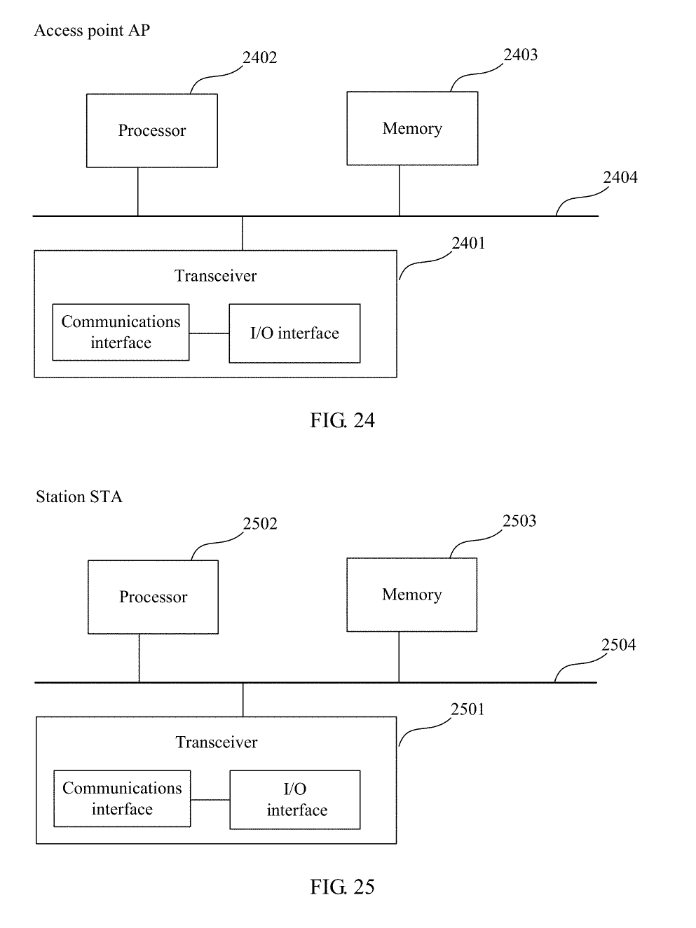

As shown in FIG. 24, the access point may include a transceiver 2401, a processor 2402, a memory 2403, and a communications bus 2404. The transceiver 2401 includes at least one communications interface and an I/O interface. The transceiver 2401 may include components such as a receiver, a transmitter, and an antenna. The access point may further include more or fewer components, combine some components, or have a different component arrangement. This is not limited in this application.

The processor 2402 is a control center of the access point, and is connected to each component of the entire access point by using various interfaces and lines. By running or executing a software program and/or module stored in the memory 2403 and invoking data stored in the memory, the processor 2402 performs various functions of the access point and/or processes data. The processor 2402 may include an integrated circuit (integrated circuit, IC for short), for example, a single encapsulated IC, or may include a plurality of connected encapsulated ICs that have same or different functions. For example, the processor may include only a central processing unit (central processing unit, CPU), or may be a combination of a GPU, a digital signal processor (digital signal processor, DSP), and a control chip (such as a baseband chip) of a transceiver module.

The transceiver 2401 is configured to establish a communications channel, so that the access point connects to a receiving device by using the communications channel, to implement data transmission between the access point and a station. The transceiver may include communications modules such as a wireless local area network (wireless local area network, WLAN) module, a Bluetooth module, and a baseband (base band) module, and radio frequency (radio frequency, RF) circuits corresponding to the communications modules. The transceiver is configured to perform wireless local area network communication, Bluetooth communication, infrared communication, and/or cellular communications system communication, for example, wideband code division multiple access (wideband code division multiple access, WCDMA) and/or high speed downlink packet access (high speed downlink packet access, HSDPA). The transceiver module is configured to control communication between components of a terminal device, and can support direct memory access (direct memory access).

In the foregoing embodiment, a function to be implemented by the transceiver unit 2201 may be implemented by the transceiver 2401 of the access point, or may be implemented by the transceiver 2401 controlled by the processor 2402; and a function to be implemented by the processing unit 2202 may be implemented by the processor 2402.

FIG. 25 is a schematic structural diagram of an embodiment of a station device according to this application. The station device may be the information receiving apparatus in the foregoing embodiments, and is configured to implement the method steps in the foregoing embodiments.

The station device may include a transceiver 2501, a processor 2502, a memory 2503, a communications bus 2504, and the like. The transceiver 2501 includes at least one communications interface and an I/O interface. The transceiver 2501 may include components such as a receiver, a transmitter, and an antenna. The station may further include more or fewer components, combine some components, or have a different component arrangement. This is not limited in this application.

The transceiver 2501 may be configured to receive or send data. The transceiver 2501 may be controlled by the processor 2502 to send data such as an acknowledgement frame to an access point device. The transceiver 2501 is controlled by the processor 2502 to receive data sent by an access point or another network-side device.

In this embodiment, the access point first configures and sends a data frame, and then instructs, by using a trigger frame carrying indication information, a plurality of stations to reply with the acknowledgement frame by using a shared resource unit, thereby optimizing a downlink data acknowledgement replying manner. A reserved field such as an AID or an MCS in the trigger frame is used to improve flexibility of configuration indication, thereby canceling a redundant dedicated replying process. Only an orthogonal code is used to complete replying of acknowledgement information of the plurality of stations by using one shared resource unit, thereby reducing frame header overheads and an interval time, and increasing a data rate and a throughput.

Further, in the access point and the station, the memory may be a read-only memory (read-only memory, ROM) or another type of static storage device that can store static information and instructions, a random access memory (random access memory, RAM) or another type of dynamic storage device that can store information and instructions, an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a blu-ray disc, or the like), a magnetic disk storage medium or another magnetic storage device, or any other medium that can be configured to carry or store expected program code in a form of an instruction or a data structure and that can be accessed by a computer. No limitation is imposed thereon. The memory may exist alone, or may be integrated into the processor. The memory is configured to store application program code executing the solutions of the present invention, and the processor controls the execution. The processor is configured to execute the application program code stored in the memory.

An embodiment of the present invention further provides a computer storage medium. The computer storage medium is configured to store a computer software instruction used in the information indication method and the information receiving method in Embodiment 1 to Embodiment 4. The computer software instruction includes a program designed for executing the foregoing method embodiments. Overheads for replying with acknowledgement frames for uplink and downlink data can be reduced by executing the stored program.

The present invention is described with reference to the flowcharts and/or block diagrams of the method, the apparatus (device), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

The same or similar components in the embodiments of this specification can be understood by reference to each other. Especially, the foregoing device embodiment is basically similar to a method embodiment, and therefore is described briefly; for related parts, refer to descriptions in the method embodiment.

The foregoing descriptions are implementations of this application, but are not intended to limit the protection scope of this application.

The following are embodiments or examples:

1. An information indication method, wherein the method comprises:

sending, by an access point, a data frame to at least one station, wherein the data frame is a non-aggregated frame or an aggregated frame obtained by aggregating N MAC frames, N is a positive integer greater than 1 and is less than or equal to M, and M is a maximum allowable quantity of aggregated MAC frames;
sending, by the access point, trigger information to the at least one station, wherein the trigger information is used to instruct the at least one station to reply with an acknowledgement frame on a shared resource unit; and receiving, by the access point, the acknowledgement frame fed back by the at least one station on the shared resource unit.

2. The method according to embodiment\example 1, wherein the trigger information comprises at least one per station field, and each per station field correspondingly indicates one station or one group of stations; and each per station field comprises at least one of the following information: a special station association identifier, a special modulation and coding scheme, and special spatial stream allocation.

3. The method according to embodiment\example 2, wherein each per station field further comprises resource unit allocation, and the resource unit allocation is used to indicate a location of the shared resource unit on which the at least one station feeds back the acknowledgement frame.

4. The method according to embodiment\example 1, wherein the trigger information is further used to instruct the at least one station to send the acknowledgement frame in a code division manner, the code division manner comprises multiplying, by a different preset orthogonal sequence, information sent by each station, and the preset orthogonal sequence comprises a Zadoff-Chu sequence, a pseudonoise PN sequence, or a Walsh code.

5. The method according to embodiment\example 1 to 4, wherein the trigger information further comprises an acknowledgement bitmap; and the acknowledgement bitmap is used to indicate whether the access point correctly receives, in previous uplink multi-user transmission, data sent by the at least one station.

6. The method according to embodiment\example 5, wherein the acknowledgement bitmap is carried by using a field in the trigger information or a field in a high efficient signal field B, wherein the field comprises a field in a common area or a per station area of the trigger information, or a field in a common area or a per station area of the high efficient signal field B.

7. An information receiving method, wherein the method comprises:

receiving, by a station, a data frame and trigger information, wherein the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame on a shared resource unit;
generating, by the station, the acknowledgement frame based on the data frame; and sending, by the station, the acknowledgement frame on the shared resource unit according to an instruction of the trigger information.

8. The method according to embodiment\example 7, wherein the sending, by the station, the acknowledgement frame on the shared resource unit according to an instruction of the trigger information comprises:

if the data frame is a non-aggregated frame, sending, by the station, the acknowledgement frame on the shared resource unit by using a preset bit.

9. The method according to embodiment\example 8, wherein the sending, by the station, the acknowledgement frame on the shared resource unit according to an instruction of the trigger information comprises:

sending, by the station, the acknowledgement frame on the shared resource unit in a code division manner according to the indication of the trigger information, wherein the code division manner comprises multiplying, by a preset orthogonal sequence, information sent by the station, and the preset orthogonal sequence comprises a Zadoff-Chu sequence, a pseudonoise PN sequence, or a Walsh code.

10. The method according to any one of embodiment\examples 7 to 9, wherein the acknowledgement frame comprises an acknowledgement bitmap; and the acknowledgement bitmap is used to indicate whether the access point correctly receives, in previous uplink multi-user transmission, data sent by the at least one station.

11. The method according to embodiment\example 10, wherein the trigger information comprises the at least one per station field, each per station field correspondingly indicates one station or one group of stations, and each per station field is used to indicate existence of the acknowledgement bitmap; and each per station field comprises at least one of the following information: a special station association identifier, a special modulation and coding scheme, and special spatial stream allocation.

12. The method according to embodiment\example 11, wherein the acknowledgement frame further comprises at least one of a high efficient signal field B and an Internet of Things signaling field IoT-SIG, and the acknowledgement bitmap is carried by using at least one of the high efficient signal field B and the IoT-SIG

13. An information indication apparatus, comprising:

a processing unit, configured to generate a data frame and trigger information, wherein the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct at least one station to reply with an acknowledgement frame on a shared resource unit; and
a transceiver unit, configured to: send the data frame and the trigger information to the at least one station, and receive the acknowledgement frame fed back by the at least one station on the shared resource unit.

14. The apparatus according to embodiment\example 13, wherein the trigger information comprises at least one per station field, and each per station field correspondingly indicates one station or one group of stations; and each per station field comprises at least one of the following information: a special station association identifier AID, a special modulation and coding scheme MCS, and special spatial stream allocation.

15. The apparatus according to embodiment\example 14, wherein each per station field further comprises resource unit allocation, and the resource unit allocation is used to indicate a location of the shared resource unit on which the at least one station feeds back the acknowledgement frame.

16. The apparatus according to embodiment\example 13, wherein the trigger information is further used to instruct the at least one station to send the acknowledgement frame in a code division manner, the code division manner comprises multiplying, by a different preset orthogonal sequence, information sent by each station, and the preset orthogonal sequence comprises a Zadoff-Chu sequence, a pseudonoise PN sequence, or a Walsh code.

17. The apparatus according to any one of embodiment\examples 13 to 16, wherein the trigger information further comprises an acknowledgement bitmap, and the acknowledgement bitmap is used to indicate whether the access point correctly receives, in previous uplink multi-user transmission, data sent by the at least one station.

18. The apparatus according to embodiment\example 17, wherein the transceiver unit is further configured to receive an information element fed back by the at least one station, wherein the information element is used to indicate whether each station supports replying with the acknowledgement frame by using at least one of the shared resource unit and the acknowledgement bitmap; and the processing unit is further configured to determine, based on the information element, a manner in which each station replies with the acknowledgement frame.

19. An information receiving apparatus, comprising:

a transceiver unit, configured to receive a data frame and trigger information, wherein the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame on a shared resource unit; and a processing unit, configured to generate the acknowledgement frame based on the data frame, wherein
the transceiver unit is further configured to send the acknowledgement frame on the shared resource unit according to an instruction of the trigger information.

20. The apparatus according to embodiment\example 19, wherein the transceiver unit is further configured to: if the data frame is a non-aggregated frame, send the acknowledgement frame on the shared resource unit by using a preset bit.

21. The apparatus according to embodiment\example 20, wherein the transceiver unit is further configured to send the acknowledgement frame on the shared resource unit in a code division manner according to the indication of the trigger information, wherein the code division manner comprises multiplying, by a different preset orthogonal sequence, information sent by each station, and the preset orthogonal sequence comprises a Zadoff-Chu sequence, a pseudonoise PN sequence, or a Walsh code.

22. The apparatus according to any one of embodiment\examples 19 to 21, wherein the acknowledgement frame comprises an acknowledgement bitmap; and the acknowledgement bitmap is used to indicate whether the access point correctly receives, in previous uplink multi-user transmission, data sent by the at least one station.

23. The apparatus according to embodiment\example 22, wherein the trigger information comprises the at least one per station field, each per station field correspondingly indicates one station or one group of stations, and each per station field is used to indicate existence of the acknowledgement bitmap; and each per station field comprises at least one of the following information: a special station association identifier, a special modulation and coding scheme, and special spatial stream allocation.

24. The apparatus according to embodiment\example 23, wherein the acknowledgement frame further comprises at least one of a high efficient signal field B and an Internet of Things signaling field IoT-SIG and the acknowledgement bitmap is carried by using at least one of the high efficient signal field B and the IoT-SIG

25. A computer-readable storage medium, comprising an instruction, wherein when the instruction runs on a computer, the computer performs the method according to any one of embodiment\examples 1 to 6, or the computer performs the method according to any one of embodiment\examples 7 to 12.

26. A computer program product, wherein when the computer program product runs on a computer, the computer performs the method according to any one of embodiment\examples 1 to 6, or the computer performs the method according to any one of embodiment\examples 7 to 12.

27. A communications device, comprising a memory, a processor, and a computer program that is stored in the memory and that can run on the processor, wherein the processor executes the program to implement the method according to any one of embodiment\examples 1 to 6 or implement the method according to any one of embodiment\examples 7 to 12.

What is claimed is:

1. An information indication method, wherein the method comprises:
sending, by an access point, a data frame to at least one station, wherein the data frame is a non-aggregated frame or an aggregated frame obtained by aggregating N MAC frames, N is a positive integer greater than 1 and is less than or equal to M, and M is a maximum allowable quantity of aggregated MAC frames;
sending, by the access point, trigger information to the at least one station, wherein the trigger information is used to instruct the at least one station to reply with an acknowledgement frame on a shared resource unit; and
receiving, by the access point, the acknowledgement frame fed back by the at least one station on the shared resource unit.

2. The method according to claim 1, wherein
the trigger information comprises at least one per station field, and each per station field correspondingly indicates one station or one group of stations; and
each per station field comprises at least one of the following information: a special station association identifier, a special modulation and coding scheme, and special spatial stream allocation.

3. The method according to claim 2, wherein
each per station field further comprises resource unit allocation, and the resource unit allocation is used to indicate a location of the shared resource unit on which the at least one station feeds back the acknowledgement frame.

4. The method according to claim 1, wherein
the trigger information is further used to instruct the at least one station to send the acknowledgement frame in a code division manner, the code division manner comprises multiplying, by a different preset orthogonal sequence, information sent by each station, and the preset orthogonal sequence comprises a Zadoff-Chu sequence, a pseudonoise PN sequence, or a Walsh code.

5. The method according to claim 1, wherein the trigger information further comprises an acknowledgement bitmap; and
the acknowledgement bitmap is used to indicate whether the access point correctly receives, in previous uplink multi-user transmission, data sent by the at least one station.

6. An information receiving method, wherein the method comprises:
receiving, by a station, a data frame and trigger information, wherein the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame on a shared resource unit;
generating, by the station, the acknowledgement frame based on the data frame; and
sending, by the station, the acknowledgement frame on the shared resource unit according to an instruction of the trigger information.

7. The method according to claim 6, wherein the sending, by the station, the acknowledgement frame on the shared resource unit according to an instruction of the trigger information comprises:
if the data frame is a non-aggregated frame, sending, by the station, the acknowledgement frame on the shared resource unit by using a preset bit.

8. The method according to claim 7, wherein the sending, by the station, the acknowledgement frame on the shared resource unit according to an instruction of the trigger information comprises:
sending, by the station, the acknowledgement frame on the shared resource unit in a code division manner according to the indication of the trigger information, wherein the code division manner comprises multiplying, by a preset orthogonal sequence, information sent by the station, and the preset orthogonal sequence comprises a Zadoff-Chu sequence, a pseudonoise PN sequence, or a Walsh code.

9. The method according to claim 6, wherein the acknowledgement frame comprises an acknowledgement bitmap; and
the acknowledgement bitmap is used to indicate whether the access point correctly receives, in previous uplink multi-user transmission, data sent by the at least one station.

10. The method according to claim 9, wherein
the trigger information comprises the at least one per station field, each per station field correspondingly indicates one station or one group of stations, and each per station field is used to indicate existence of the acknowledgement bitmap; and
each per station field comprises at least one of the following information: a special station association identifier, a special modulation and coding scheme, and special spatial stream allocation.

11. An information indication apparatus, comprising:
a processing unit, configured to generate a data frame and trigger information, wherein the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct at least one station to reply with an acknowledgement frame on a shared resource unit; and
a transceiver unit, configured to: send the data frame and the trigger information to the at least one station, and receive the acknowledgement frame fed back by the at least one station on the shared resource unit.

12. The apparatus according to claim 11, wherein
the trigger information comprises at least one per station field, and each per station field correspondingly indicates one station or one group of stations; and
each per station field comprises at least one of the following information: a special station association identifier AID, a special modulation and coding scheme MCS, and special spatial stream allocation.

13. The apparatus according to claim 12, wherein
each per station field further comprises resource unit allocation, and the resource unit allocation is used to indicate a location of the shared resource unit on which the at least one station feeds back the acknowledgement frame.

14. The apparatus according to claim 11, wherein
the trigger information is further used to instruct the at least one station to send the acknowledgement frame in a code division manner, the code division manner comprises multiplying, by a different preset orthogonal sequence, information sent by each station, and the preset orthogonal sequence comprises a Zadoff-Chu sequence, a pseudonoise PN sequence, or a Walsh code.

15. The apparatus according to claim 11, wherein
the trigger information further comprises an acknowledgement bitmap, and the acknowledgement bitmap is used to indicate whether the access point correctly receives, in previous uplink multi-user transmission, data sent by the at least one station.

16. An information receiving apparatus, comprising:
a transceiver unit, configured to receive a data frame and trigger information, wherein the data frame is a non-aggregated frame or an aggregated frame obtained by aggregating N MAC frames, N is a positive integer greater than 1 and is less than or equal to M, M is a maximum allowable quantity of aggregated MAC frames, and the trigger information is used to instruct the station to reply with an acknowledgement frame on a shared resource unit; and
a processing unit, configured to generate the acknowledgement frame based on the data frame, wherein
the transceiver unit is further configured to send the acknowledgement frame on the shared resource unit according to an instruction of the trigger information.

17. The apparatus according to claim 16, wherein
the transceiver unit is further configured to: if the data frame is a non-aggregated frame, send the acknowledgement frame on the shared resource unit by using a preset bit.

18. The apparatus according to claim 17, wherein
the transceiver unit is further configured to send the acknowledgement frame on the shared resource unit in a code division manner according to the indication of the trigger information, wherein the code division manner comprises multiplying, by a different preset orthogonal sequence, information sent by each station, and the preset orthogonal sequence comprises a Zadoff-Chu sequence, a pseudonoise PN sequence, or a Walsh code.

19. The apparatus according to claim 16, wherein the acknowledgement frame comprises an acknowledgement bitmap; and
the acknowledgement bitmap is used to indicate whether the access point correctly receives, in previous uplink multi-user transmission, data sent by the at least one station.

20. The apparatus according to claim 19, wherein
the trigger information comprises the at least one per station field, each per station field correspondingly indicates one station or one group of stations, and each per station field is used to indicate existence of the acknowledgement bitmap; and
each per station field comprises at least one of the following information: a special station association identifier, a special modulation and coding scheme, and special spatial stream allocation.
